(19) United States
(12) Patent Application Publication
(10) Pub. No.: US 2015/0319669 A1
(43) Pub. Date: Nov. 5, 2015

(54) FORWARDING OF SERVICE REQUESTS BY A WIRELESS CONTROLLER

(71) Applicant: HEWLETT-PACKARD DEVELOPMENT COMPANY, L.P., Houston, TX (US)

(72) Inventor: Reinoud Jeroen KOORNSTRA, Roseville, CA (US)

(21) Appl. No.: 14/654,810

(22) PCT Filed: Dec. 21, 2012
(86) PCT No.: PCT/US2012/071302

§ 371 Date: Jun. 22, 2015

(51) Int. Cl. H04W 40/04; H04W 8/18; H04W 8/26; H04L 12/741; H04L 29/12

(52) U.S. Cl. CPC H04W 40/04; H04L 45/74; H04L 61/2023; H04L 61/2015; H04W 8/26; H04W 8/183

(57) ABSTRACT

A wireless controller receives a service request having a header with a broadcast destination address. The wireless controller determines a port on which a reply to a similar service request was previously received and forwards the service request as a packet with a header having a broadcast destination address, out of said port on which a reply to a similar service request was previously received.

### BACKGROUND

A Wireless Controller (WC) is a device which manages wireless Access Points (APs). For example, a Wireless Controller may monitor the traffic load and available bandwidth for each access point which it manages. In most cases the Access Points forward client device authentication and joining requests to the Wireless Controller for processing. Once a client device has joined a wireless network it typically uses DHCP, or another protocol, to obtain an IP address which it can use in communications with the network.

### BRIEF DESCRIPTION OF THE DRAWINGS

Examples of the invention will now be described, by way of non-limiting example only, with reference to the accompanying drawings, in which:

FIG. 1 shows an example of a network including a Wireless Controller;

FIG. 2 shows an example of a method for controlling broadcasts of service requests in a wireless network; and

FIG. 3 shows an example of a header of a broadcast service request.

### DETAILED DESCRIPTION

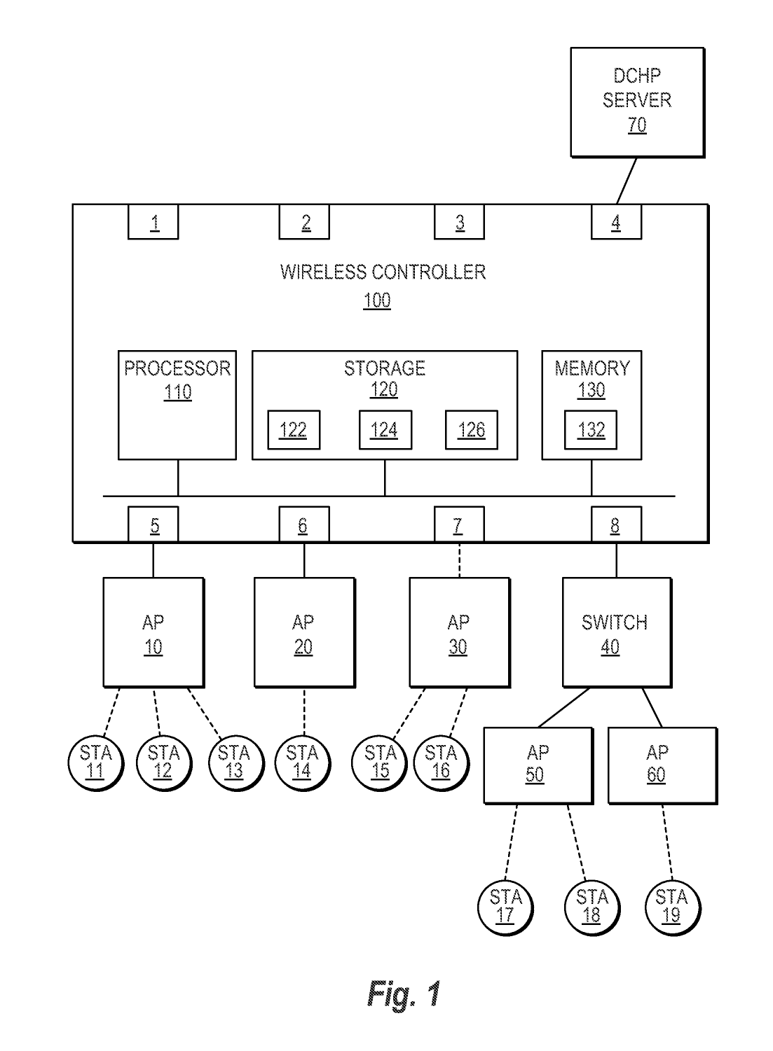

FIG. 1 shows an example of a network including a plurality of client devices (also referred to as ‘Stations’ or ‘STA’) 11-19. A client device may be a computer, mobile phone, tablet device etc, or any device which has wireless functionality and uses a wireless protocol to communicate with an Access Point (AP). Each client device connects wirelessly with a respective AP 10, 20, 30, 40, 50, 60 as indicated by the dashed lines in FIG. 1.

A Wireless Controller (WC) 100 manages the APs, e.g. by controlling certain configuration settings of the APs. In some, but not all cases, the Wireless Controller may manage the AP's traffic as well and act as a central point through which all AP traffic passes.

The Wireless Controller 100 is usually set up to communicate with the APs through a direct wired connection, as shown for APs 10 and 20, or an indirect wired connection (e.g. via a switch or hub 40) as shown for APs 50 and 60, but in some cases may communicate with other devices via a wireless connection as shown for AP 30. The wired connections may for example be Ethernet cables and are indicated by solid lines in FIG. 1. The wireless connections are indicated by dashed lines and may use any suitable protocol such as 802.11a, 802.11b, 802.11g, 802.11n, 802.11ac, 802.11ad or another wireless or WLAN (Wireless Local Area Network) protocol. Each AP may have one radio, or several radios, which are to communicate with corresponding radios of the client devices, wireless controller or other devices. If the AP has several radios, each radio may support a different protocol and/or frequency band.

While only a relatively small number of APs and radios are shown in the example of FIG. 1, in many cases there may be a larger number of APs and radios. For example, on a student campus a WC may manage 100 or more APs and each AP may have two or more radios (e.g. one for 802.11b/g communications and one for 802.11n communications). In such situations a broadcast from the WC could result in 200 or more packets being forwarded by the APs. As radio bandwidth is a limited resource this can cause congestion and compromise system performance. Once a client device has joined an AP, the client device typically broadcasts a service request for an address or other configuration information, to enable it communicate with the network. For example, it may broadcast a service request for an IP address. Examples of service requests include, but are not limited to, a DHCP Discover packet, a DHCP Request, a Netbios name request, or a BootP request. A ‘broadcast service request’ is a service request which has a header with broadcast destination address. For example in IP v4 networks the broadcast destination address is typically defined as 255.255.255.255; however, other broadcast destination addresses may exist and be used. A switch receiving a packet having a broadcast destination address typically forwards the packet out of all of its ports on the same VLAN (Virtual Local Area Network), except the port on which the packet was received.

When an AP receives a broadcast service request it forwards this broadcast service request to the WC (the AP typically does not forward the service request to other clients connected to the AP). In some examples communication between the AP and the WC may be via a tunnel between the AP and the WC. In that case the AP may encapsulate the broadcast service request in a tunneling protocol and forward it to the WC. The encapsulated broadcast service request is de-encapsulated upon receipt by the WC. For example, the tunneling protocol might be GRE (Generic Routing Encapsulation), or a proprietary tunneling protocol (which may encapsulate the service request and other packets into a layer 2 protocol).

According to one example in accordance with the present disclosure, the Wireless Controller determines the port ID of a port on which a reply to a similar type of service request was previously received by the Wireless Controller. The Wireless Controller then forwards the broadcast service request out of that port. In this way the broadcast service request is not forwarded out of all ports of the Wireless Controller. This may help to reduce wireless traffic in the WLAN.

In one example, the service request is forwarded out of said port as a packet which has a broadcast destination address in its header. This relieves the load on the Wireless Controller as if the packet is forwarded with a broadcast destination address, the Wireless Controller need not perform processing to determine a unicast header for the service request. Further, in some cases, the WC may have cheaper or less complicated circuitry as it does not need to determine a unicast header for the service request.

An example of the Wireless Controller and an example method of using the Wireless Controller to process service requests will now be described in more detail.

As shown in FIG. 1, the Wireless Controller 100 has a plurality of ports 1-8. Ports 1 and 2 are LAN (Local Area Network) ports and are connected to Access Points 10 and 20 respectively by wired connections such as Ethernet cables. Port 3 is a radio port and includes a radio which wirelessly connects to Access Point 30 (while a wireless connection between the WC and the AP is not a common set-up, it is used in some networks). Port 4 is a LAN port which is connected by a wired connection to switch 40 and switch 40 is connected to Access Points 50 and 60. Port 5 of the Wireless Controller is connected to a DHCP server 70, while ports 6-8 may be connected to the rest of the wired network (not shown), for example to switches, routers or servers etc. Of course, this is just an example and the Wireless Controller may have more ports, or fewer ports, different types of ports, and/or the ports may have different connections. For example, while in FIG. 1 a DHCP server 70 is directly connected to a wired LAN port of the Wireless Controller, in other examples the DHCP server may be connected indirectly via a switch or hub, or may even reside on another sub-net. In still other examples, a group of DHCP servers may be accessible via a port of the Wireless Controller. In another example the Wireless Controller may connect with a DHCP server wirelessly, either directly through a wireless port of the Wireless Controller or indirectly via an AP.

The Wireless Controller has a processor 110 which is able to access a memory 130. The memory includes an area 132 that stores the port ID of a port of the Wireless Controller on which a reply to a service request has previously been received. The Wireless Controller also includes a storage media 120 and machine readable instructions stored on the storage media 120. The processor 110 is able to access the storage media and execute the modules of machine readable instructions.

The modules may include an AP management module 122 for managing the APs, a data forwarding module 124 for forwarding data to and from APs and a service request module 126 for handling service requests received from the APs. In other examples, the processor 110 may include logic, such as an ASIC, FPGA hardwired or configured to implement the functionality of these modules without reading machine readable instructions from a separate memory, or a combination of hardware and machine readable instructions may be used.

The AP management module 122 may include logic for any one, or all of, monitoring the workload of the APs, traffic levels, allocating radio channels to the APs, processing or forwarding authentication and join requests, encryption, decryption, handling roaming of client devices between APs etc. The data forwarding module 124 may include logic to send and receive data packets between the WC and the APs and for forwarding data packets received from APs to other parts of the network and forwarding packets from other parts of the network to the AP. The data forwarding module may include logic for setting up a tunnel between the WC and each AP so that packets between the WC and each AP may be encapsulated using a protocol for communication between a WC and APs.

In some cases the AP may have further modules to perform traffic shaping (QoS (Quality of Service)), access control based on an access control list, firewall and/or other functions.

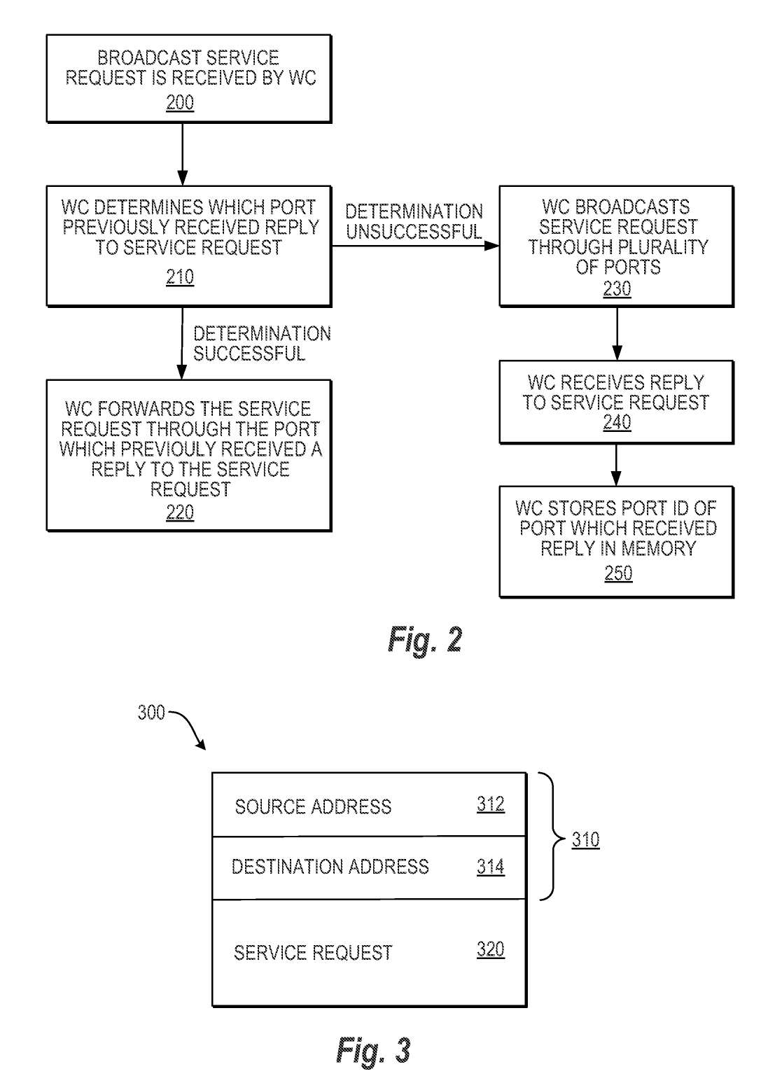

The service request module 126 and the memory 130 are used to process broadcast service requests (e.g. requests for an address or configuration information, such as DHCP requests) which may be generated by a client and sent to an AP when the client first joins the wireless network. The AP forwards these requests to the Wireless Controller for handling. This will be described in more detail below with reference to FIG. 2.

After a client device has joined (successfully associated with) an AP, it typically broadcasts a service request. For example, a DHCP discover packet, a DHCP request, a BootP request, a Netbios name request etc. The broadcast service request is received by the client's AP and the AP forwards the request to the Wireless Controller.

At block 200 the Wireless Controller (WC) receives a broadcast service request from an AP. At block 210 the WC determines the port ID of a port on which the WC has previously received a reply to a similar type of service request. For example, if the WC receives a DHCP Discover packet it determines the port ID of a port on which it has previously received a response from a DHCP server (for instance the response may have been to a DHCP Discover packet or DHCP Request).

The WC may conduct this determination by checking the contents of memory 130. If memory 130 contains data 132 indicating a port ID of a port on which a service request of a similar type was previously received by the WC, then the determination is positive and the method proceeds to block 220.

At block 220 the Wireless Controller forwards the broadcast service request out of the port indicated by the port ID determined in block 210 (i.e. the port through which the service provider, for instance the DHCP server or other service providing server, can be reached). The Wireless Controller does not forward the service request through ports on which a reply to the service request has not previously been received. This helps to reduce traffic in the network.

In most cases, the service request is only forwarded through a single port of the wireless controller. The port may be a wired port or a wireless port. If the service request is transmitted wirelessly, then in order to further reduce wireless traffic the service request may forwarded over only a single radio channel (for instance, the radio channel on which a response was previously received). In accordance with one example the broadcast service request is forwarded with a header having a broadcast destination address.

An example of one way in which the Wireless Controller may store in memory the port ID of the port through which to forward service requests will now be discussed with reference to blocks 210 to 250 of FIG. 2.

At block 210 the WC may inspect the memory 210 and determine that it has not previously received a reply to a similar type of service request. In that case at block 230 the WC forwards the service request out of a plurality of ports of the WC (for example it may forward the service request out of all ports of the WC, all ports except the port on which the service request was received, or a subset of the ports of the wireless controller). At block 240 the WC receives a reply to the service request at one of its ports. At 250 the WC stores the port ID of the port on which the reply was received in the memory 130.

This typically occurs when the WC first receives a service request after having been added to the network, or when the WC has just been turned on or reset (so its memory has cleared. In some cases the port ID stored in the memory may be aged, so that it is set upon receipt of a reply to service request, and it is cleared after a certain period of time.

After the service request is forwarded at block 220 or 230 of FIG. 2, the WC typically receives a reply from a service provider (e.g. a DHCP server). The WC then forwards the reply to the client which originally made the service request. For example, it may forward the reply to an AP which the client is associated with. Unless the client has roamed to another AP, this will usually be the same AP which originally sent the service request to the WC. In some implementations communications between the WC and the AP, including the reply to the service request, may be encapsulated in a tunneling protocol. Examples of a reply to a service request include a DHCP Offer, DHCP Acknowledge, DHCP Decline, Boot Reply packet etc.

FIG. 3 shows a simplified example of the structure of a service request packet 300. The service request includes a header 310 and service request body 320. The header comprises a source address 312 and a destination address 314. While not shown in FIG. 3, the header may have further fields, such as source port, destination port, length and checksum etc.

The source address 312 is the address of the device sending the service request, which may for instance be 0.0.0.0 in the case of a client device which has not yet received an IP address.

The destination address 314 is the address of the device which a packet is to be forwarded to. A broadcast destination address is a special address which causes the receiving device to broadcast the packet through all of its ports except the port on which it was received, or to broadcast the packet through all ports including the port on which the packet was received. For instance, the broadcast address may be 255.255.255.255.

According to one example the destination address 314 of the broadcast service request is not changed between the receipt of the service request by the WC and forwarding of the service request by the WC. E.g. both the received and forwarded packet have the same destination address. The destination address may for example be a broadcast address such as 255.255.255.255 for an IP v4 network. In other cases, such as an IP v6 network, the broadcast address may be a multicast address to the ‘all hosts’ multicast group.

According to one example, the header 310 is unchanged as between the receipt and forwarding by the WC. That is neither the source nor the destination address are changed. This further reduces the processing load on the WC.

According to another example the destination address in the header 310 of the broadcast service request is not changed, but the WC changes the source address in the header to the address of the WC before forwarding through the determined port to the service provider server. This enables the WC to act as a lightweight DHCP helper or agent, but may take more processing power.

The body of the service request 320 may for example include any or all of message type, client identifier, server identifier, requested address fields and various option fields, which enable a service provider server to process and respond to the service request.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of controlling broadcast of service requests over a wireless network, comprising:
a wireless controller receiving a service request having a header with a broadcast destination address,
the wireless controller determining a port on which a reply to a similar service request was previously received and forwarding the service request as a packet with a header having a broadcast destination address, out of said port on which a reply to a similar service request was previously received.

2. The method of claim 1 wherein the destination address of the forwarded service request is the same as the destination address of the service request received by the wireless controller.

3. The method of claim 1 wherein a header of the service request is unchanged by the forwarding.

4. The method of claim 1 wherein the wireless controller is located on a first subnet and wherein the wireless controller forwards the service request to a server, or server group, located on a second subnet.

5. The method of claim 1 wherein the wireless controller receives the service request from an AP.

6. The method of claim 1 wherein the service request includes a request for an IP address.

7. The method of claim 1 wherein the service request is a DHCP Request, a DHCP Discover packet, a BOOTP request or a NetBios service request.

8. The method of claim 1 wherein the wireless controller forwards the service request over a wired port.

9. The method of claim 1 wherein the wireless controller forwards the service request over a wireless port.

10. The method of claim 1 wherein the wireless controller forwards the service request over a single radio channel.

11. The method of claim 1 wherein after a first reply to a service request is received at a port of the wireless controller, service requests of a similar type received by the wireless controller are forwarded through the same single port of the wireless controller until the wireless controller is reset or reconfigured by a network administrator.

12. A wireless controller comprising a plurality of ports, a processor to process packets received at ports of the wireless controller and a memory, wherein the processor is to store in said memory a port ID of a port through which the service provider can be reached and upon receiving a broadcast service request at one of said plurality of ports, the processor is to forward the broadcast service request only through the port corresponding to said port ID stored in said memory without changing a destination address in a header of the broadcast service request.

13. A wireless controller comprising a plurality of ports, an access point management module to manage access points, a memory and a service request module to receive from one of said ports a broadcast service request, inspect the memory to determine on which port a reply to a previous broadcast service request was received by the wireless controller and to forward the broadcast service request as a packet with a broadcast header through a port on which the memory indicates that a reply to a previous broadcast service request was received, without forwarding the broadcast service request through other ports of the wireless controller.

14. The wireless controller of claim 13 wherein if the memory does not indicate a port on which a reply to a broadcast service request was previously received by the wireless controller, then the service request module is to broadcast the service request out of a plurality of ports of the wireless controller and when a reply to the broadcast service request is received by the wireless controller, record in the memory the port ID of the port on which the reply was received.

15. The wireless controller of claim 13 wherein after a first reply to a particular type of service request is received by the wireless controller, the service request module is to forward subsequent broadcast service requests of a similar type received by the wireless controller through the port on which the first reply to that type of service request was received by wireless controller.
